(19) United States
(12) Patent Application Publication
(10) Pub. No.: US 2013/0124276 A1
(43) Pub. Date: May 16, 2013

(54) METHOD FOR ADVERTISING ON A SMART PHONE LOCK SCREEN

(71) Applicant: Marbue Brown, Sammamish, WA (US)

(72) Inventor: Marbue Brown, Sammamish, WA (US)

(21) Appl. No.: 13/679,733

(22) Filed: Nov. 16, 2012

Related U.S. Application Data
(60) Provisional application No. 61/560,730, filed on Nov. 16, 2011.

(51) Int. Cl. G06Q 30/02

(52) U.S. Cl. CPC G06Q 30/0241
USPC 705/14.4

(57) ABSTRACT

A smart phone lock screen advertising system is based on a software application that integrates with affiliate websites as well as ad networks and continuously displays daily deals (or other content or ads) on the phone lock screen whenever the screen is awake. The smart phone lock screen advertising may provide a direct link to view the details of a deal (or other content) as well as a link to make a purchase, for example. As such, the smart phone lock screen advertising system of the present invention may ring ad content to a top layer of a smart phone's user interface as opposed to three or more layers deep.

### CROSS-REFERENCE TO RELATED APPLICATION

This application claims the benefit of priority of U.S. provisional application No. 61/560,730, filed Nov. 16, 2011, the contents of which are herein incorporated by reference.

### BACKGROUND OF THE INVENTION

The present invention relates to advertising systems and, more particularly, to a business process for advertising daily deals and other offers on smart phone lock screens.

Smart phone users who subscribe to daily deals programs, such as Groupon® or Tippr® need to be able to view deals in a timely manner and act on the ones that interest them quickly, as deals are time bound or bound by purchase volumes and could expire before the subscriber has time to act. Currently, phone users have to go through several layers of clicks to get to information about daily deals. At a minimum, they have to unlock the phone, scroll through icons to find the appropriate application and then launch it before they can view deals. Due to all the steps involved, they frequently miss out on deals because they never get around to executing all of these steps to get information about deals.

Similarly, advertisers need a minimally intrusive way to get content to smart phone users that doesn't require them to open an application before viewing content.

As can be seen, there is a need for a method for delivering advertising to smart phones that is timely, yet unobstrusive.

### SUMMARY OF THE INVENTION

In one aspect of the present invention, a non-transient computer readable medium has computer usable program code embodied therewith, the computer program code comprises computer program code configured to display one or more advertisements on a lock screen of a computing device; and computer program code adapted to permit a user to link to the advertisement by clicking on the advertisement and unlocking the device.

In another aspect of the present invention, a method of delivering content to a smart phone user comprises displaying one or more content on a lock screen of a smart phone.

These and other features, aspects and advantages of the present invention will become better understood with reference to the following drawings, description and claims.

### BRIEF DESCRIPTION OF THE DRAWINGS

FIG. 1 is a flow chart describing a smart phone lock screen advertising process according to an exemplary embodiment of the present invention;

FIG. 2 is a flow chart describing a smart phone lock screen advertising process when the phone is off;

FIG. 3 is a flow chart describing a smart phone lock screen advertising process when the phone is on and the screen is asleep and the user wakes the screen;

FIG. 4 is a flow chart describing a smart phone lock screen advertising process when the phone is on and the screen is asleep and a phone event wakes the screen;

FIG. 5 shows screen shots of a smart phone lock screen advertising process according to an exemplary embodiment of the present invention;

FIGS. 6A, 6B, 7A and 7B are close-up views of the screen shots of FIG. 5.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a smart phone lock screen advertising system that is based on a software application that integrates with affiliate websites as well as ad networks and continuously displays daily deals (or other content or ads) on the phone lock screen whenever the screen is awake. The smart phone lock screen advertising system may provide a direct link to view the details of a deal (or other content) as well as a link to make a purchase, for example. As such, the smart phone lock screen advertising system of the present invention may ring ad content to a top layer of a smart phone's user interface as opposed to three or more layers deep.

The smart phone lock screen advertising system may provide several improvements over the traditional manner of advertising. For example, the system may eliminate multiple steps to get to ad content by displaying the content in plain sight on the phone lock screen without the need to open a web page. The system may also make ad content for daily deals (or other promotional offers) accessible to phone users in real time as a somewhat passive activity versus one that requires effort on the part of the phone user. The system may convert the phone lock screen from a basic security utility into a web services platform for serving ads without the necessity of a browser or loss of any lock screen security features. The system may also enable smart phone users to extract productive use from their phone's idle state by automatically serving content to the lock screen that they have pre-determined to be pertinent. Finally, the system may enable ad serving to become a passive activity versus one that requires active participation on the part of the phone user.

The smart phone lock screen system may include four layers as follows: 1) A platform layer may include the phone operating system and associated development tools that enable a presentation layer. 2) The presentation layer may display content on the smart phone lock screen. 3) An integration layer may connect with affiliate websites or ad networks to acquire content to display and to track usage statistics, such as clicks, page views and purchases. 4) An optional customization layer may enable end-users to customize the content they view on their lock screen, how fast that content is displayed, how long their lock screen stays awake and other relevant parameters.

Additional optional elements may be added to the smart phone lock screen system to make it a more robust business process. For example, a mechanism may be added for giving smart phone users rebates for any purchases made after navigating to ad content from their lock screen. The application may integrate with GPS to enable the smart lock screen application to serve ads based on the end-user's physical location in addition to or in lieu of hard coded, pre-selected location parameters. The application may also integrate with public safety systems to push emergency alerts to end-user's lock screens. The application may also integrate with news feeds to push breaking news headlines to end-user's lock screens.

The smart phone lock screen advertising is a business process that is operationalized through a software application that integrates with affiliate websites as well as ad networks and serves ad content to the phone lock screen. Typically, the application will be an integrated system that functions automatically once it is installed on an end-user's phone. Once the application is installed, end-users can configure the application to reflect their preferences, e.g., what type of content is served to their phone screen, the speed at which the content is cycled, and how long the screen stays awake.

The smart lock screen application may be software created using software development tools for Windows® phone, Android®, iPhone® and other smart phone platforms. The application may utilize APIs, RSS feeds and other related technologies to integrate with affiliate web sites or ad networks to acquire ad content to be displayed as well as to track clicks, page views and purchases.

While the current description focuses on smart phones, other computing devices that have a lock screen may benefit from an application of the present invention. For example, tablet computers (e.g., iPad®, Kindle® and the like), laptop computers, and desktop computers may use similar applications.

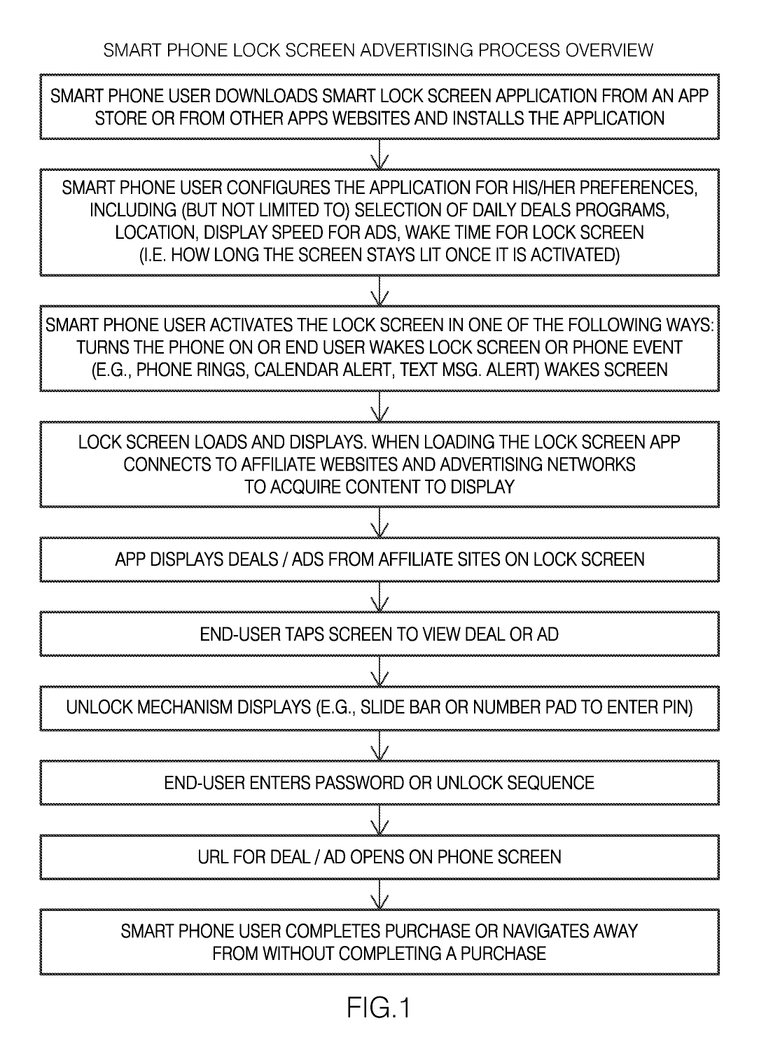

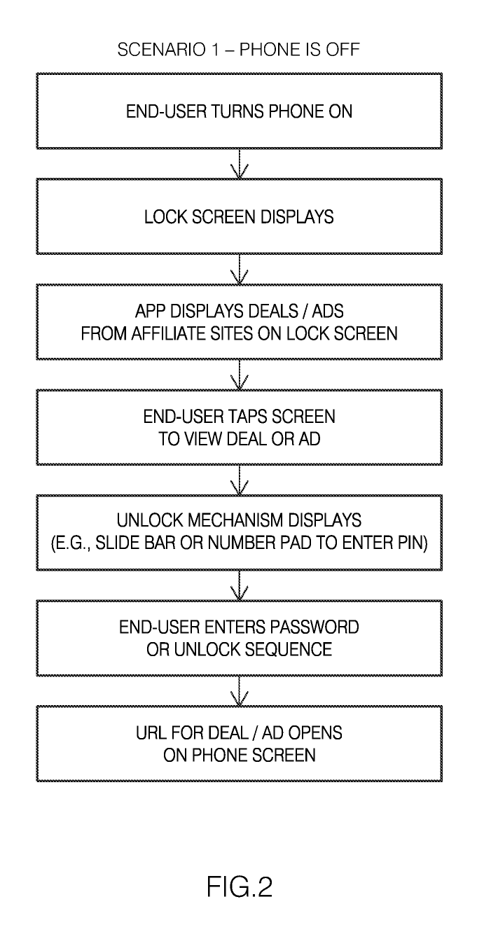

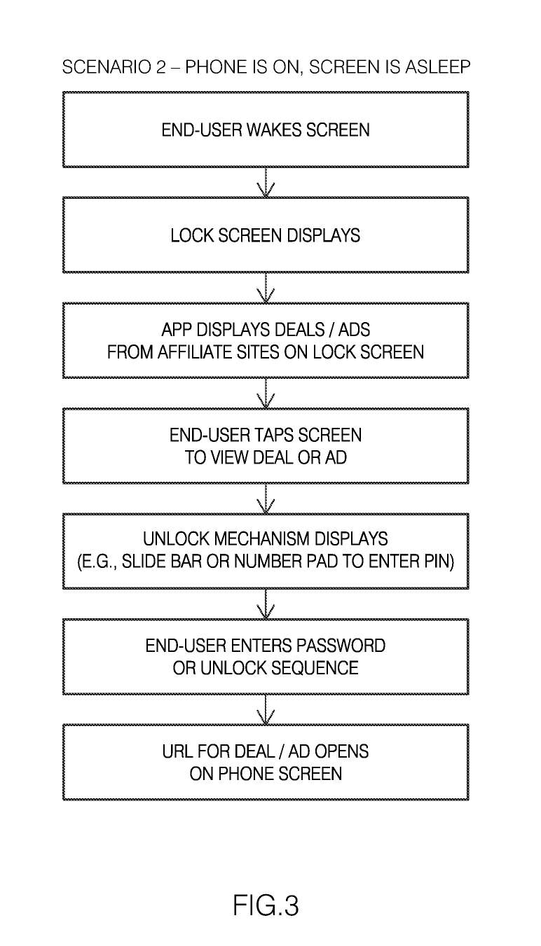

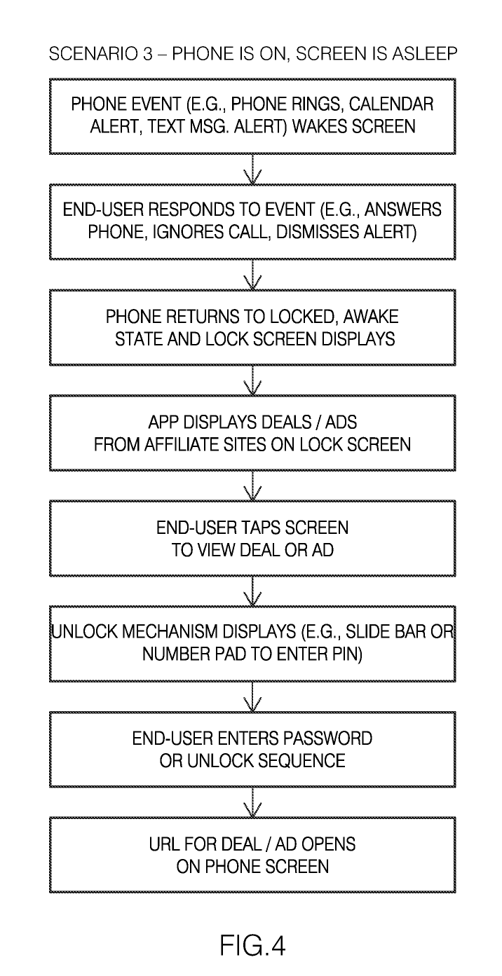

Referring now to FIGS. 1 through 4, various processes are shown to use the above described smart phone lock screen advertising technology. FIG. 1 describes an overall process overview. FIG. 2 shows a process when the phone is off. FIGS. 3 and 4 show processes for when the phone is on and the screen is asleep. In the process of FIG. 3, the screen may be awakened by the user. In the process of FIG. 4, the screen may be awakened by a phone event, such as the phone ringing, a calendar alert, a text message alert, or the like.

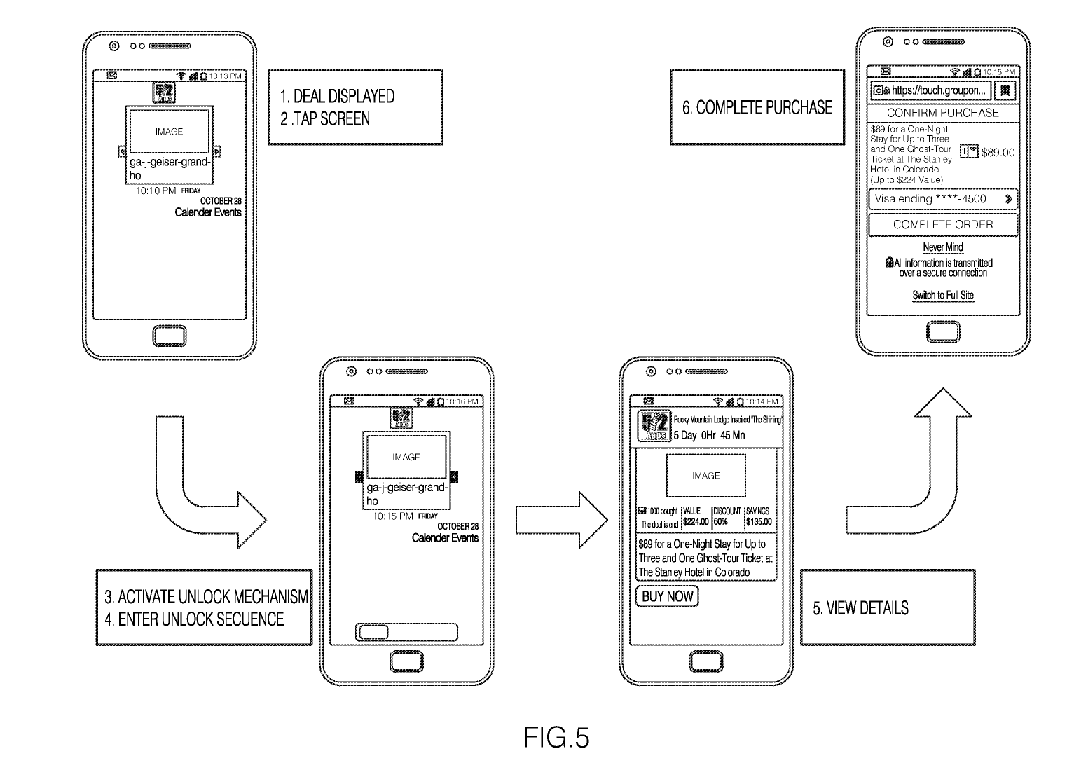

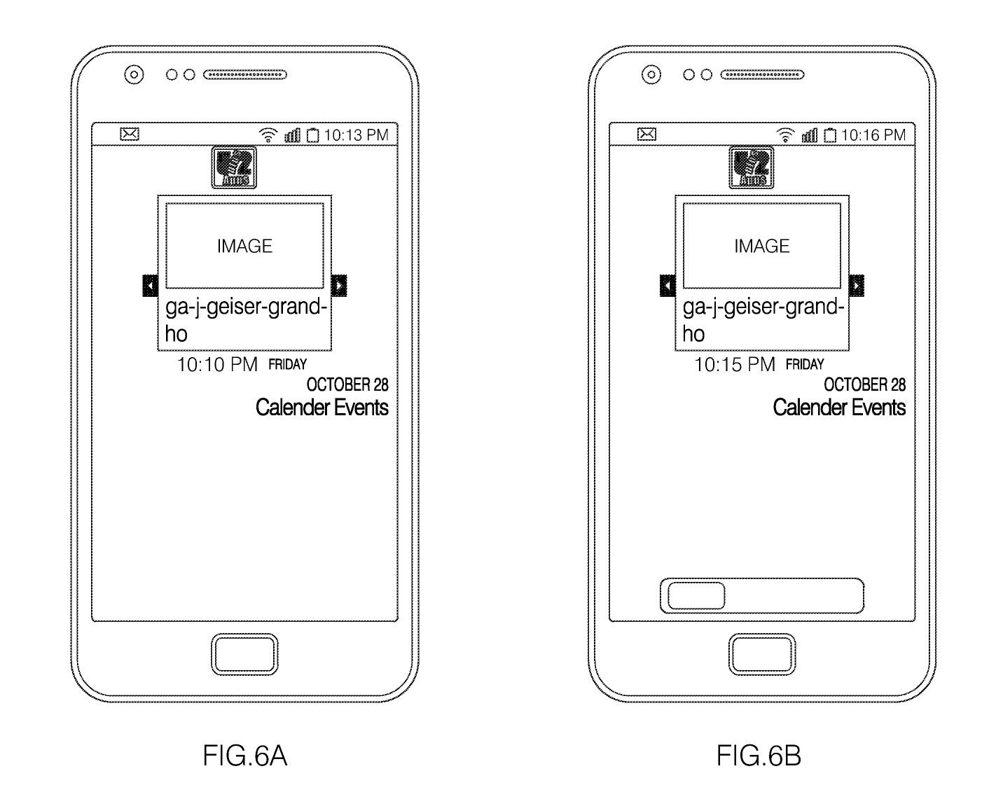

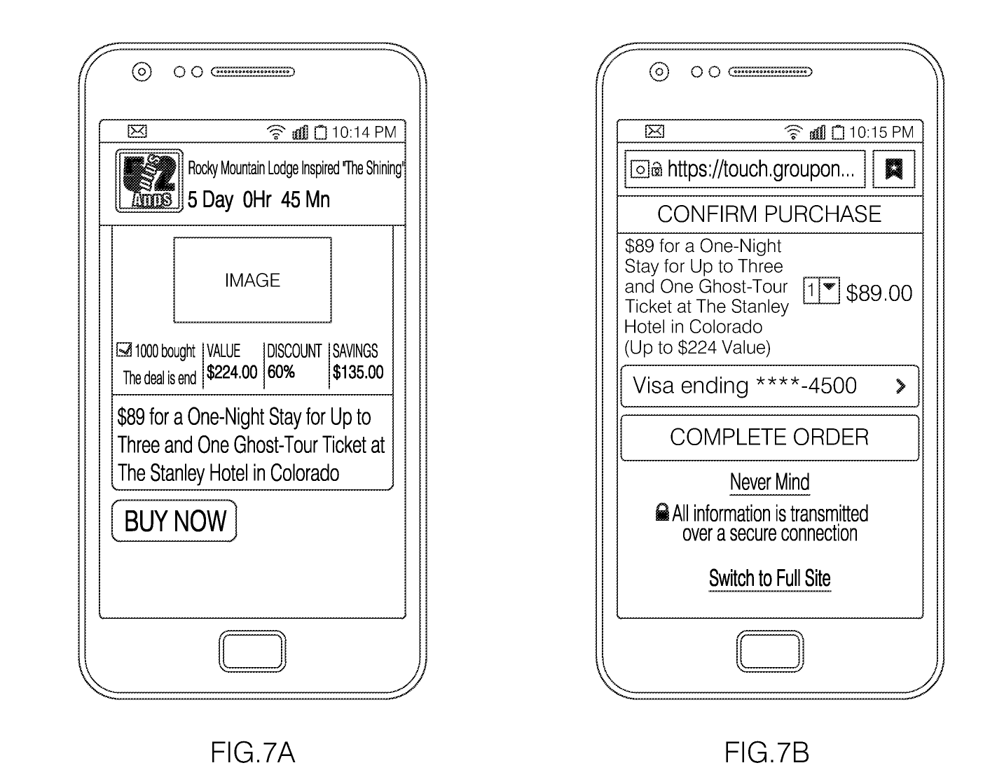

FIGS. 5-7B show screen shots of the application working on a smart phone. As can be seen in step 1 of FIG. 5 (FIG. 6A), the deal may be displayed on a smart phone lock screen. The user may tap the screen (step 3) to activate the unlock mechanism in step 3 of FIG. 5 (FIG. 6B). Once the phone is unlocked (step 4), the user may tap on the displayed deal to bring up its details in step 5 of FIG. 5 (FIG. 7A). If the user is interested in the deal, the user may make a purchase as shown in step 6 of FIG. 5 (FIG. 7B).

It should be understood, of course, that the foregoing relates to exemplary embodiments of the invention and that modifications may be made without departing from the spirit and scope of the invention as set forth in the following claims.

What is claimed is:

1. A non-transient computer readable medium having computer usable program code embodied therewith, the computer program code comprising:
computer program code configured to display one or more advertisements on a lock screen of a computing device; and
computer program code adapted to permit a user to link to the advertisement by clicking on the advertisement and unlocking the computing device.

2. The computer readable medium of claim 1, further comprising computer program code configured to accept user preferences, the user preferences including at least one of selection of daily deal programs, location selection, display speed for advertisements, and wake time for the lock screen.

3, The computer readable medium of claim 1, further comprising computer program code configured to allow the user to complete a purchase from the advertisement or navigate away from the advertisement without completing a purchase.

4. A method of delivering content to a smart phone user, comprising:
displaying one or more content on a lock screen of a smart phone.

5. The method of claim 4, wherein the content includes one or more advertisements.

6. The method of claim 5, further comprising activating the lock screen and displaying the one or more advertisements by turning on the phone.

7. The method of claim 5, further comprising activating the lock screen and displaying the one or more advertisements by waking the lock screen by user intervention or by a phone event occurring.

8. The method of claim 4, wherein the content includes one or more news feeds.

9. The method of claim 4, wherein the content includes one or more public safety announcements.

10. The method of claim 4, further comprising acquiring content while displaying the lock screen to the user.

11. The method of claim 10, further comprising displaying an unlock mechanism on the lock screen of the smart phone.

12. The method of claim 11, further comprising displaying the content after the user engages the unlock mechanism.

13. The method of claim 12, further comprising providing a first option for the user to obtain more details about the content and a second option to navigate away from the content without making a purchase.
